(19) United States
(12) Patent Application Publication
(10) Pub. No.: US 2026/0335798 A1
(43) Pub. Date: Oct. 29, 2026

(54) A FILTER MEDIUM AND A METHOD OF MANUFACTURING THE FILTER MEDIUM

(71) Applicant: AHLSTROM OYJ, Espoo (FI)

(72) Inventors: Elise RUIZ, Saint-Egreve (FR); Andrea CORRADI, Turin (IT); Outi SOIKKELI, Tampere (FI); Laura YLI-RANTALA, Tampere (FI)

(21) Appl. No.: 19/115,407

(22) PCT Filed: Oct. 2, 2023
(86) PCT No.: PCT/FI2023/050561

§ 371 Date: Mar. 26, 2025

Related U.S. Application Data
(60) Provisional application No. 63/377,790, filed on Sep. 30, 2022.
(60) Provisional application No. 63/387,993, filed on Dec. 19, 2022.

(51) Int. Cl. B01D 39/16

(52) U.S. Cl. CPC B01D 39/163; B01D 2239/0478; B01D 2239/0618; B01D 2239/064; B01D 2239/065; B01D 2239/08; B01D 2239/10; B01D 2239/1233; B01D 2239/1258; B01D 2239/1291

(57) ABSTRACT

The present invention relates to a novel filter medium, to a method of manufacturing the filter medium, to filter units comprising the filter medium, and to the use of the filter medium in a method of filtering a gas or a liquid. Specifically, the invention relates to a filter medium that provides improved capacity and efficiency, in particular improved dust holding capacity and longer filter lifetime compared to prior filter media, combined with a possibility to optimize the filter design for various applications.

### FIELD

The present invention relates to a novel filter medium, to a method of manufacturing the filter medium, to filter units comprising the filter medium, and to the use of the filter medium in a method of filtering a gas or a liquid. Specifically, the invention relates to a filter medium that provides improved capacity and efficiency, in particular improved dust holding capacity and longer filter lifetime compared to prior filter media, combined with a possibility to optimize the filter design for various applications.

### BACKGROUND

Global demand for access to clean air and energy saving filtration solutions is increasing rapidly, due to population and economic growth. This rising demand and the urgency to protect human health creates new challenges for the filtration market and encourages filtration technology companies to develop next-generation solutions. Moreover, the support for clean transportation has promoted awareness and facilitated electric vehicle adoption, which lead to the need of innovative filtration solutions in this context.

Various filter media for filtering impurities from the atmosphere, vapors and fluids are available. However, there is an increasing need to improve the performance of those filter media and design new structures for oil filtration media, air intake filtration in the transportation area as well as in the field of gas turbines. Moreover, indoor air quality has become even more important and therefore efficient heating, ventilation and air conditioning (HVAC) filters are required.

To at least partly solve the above-mentioned problems, prior art has suggested filter media that are made of multiple layers of different porosities. Wet-laid nonwoven technology leading to three-layer filtration media is disclosed for example in WO 2015/000806 A1. The structure of such three-layer wet-laid synthetic nonwoven filter media has followed an A-B-A type structure with hour-glass gradient, where A layers have the same fiber mix whereas layer B typically has a different fiber mix.

However, the above disclosed three-layer media do not provide sufficient flexibility in terms of product design and tailoring filter media with higher dust holding capacity and improved efficiency and capacity, while also providing savings in raw materials. It is therefore an object of the present invention to provide an improved filter medium, which provides improved capacity and efficiency, in particular improved dust holding capacity and longer filter lifetime compared to prior filter media, combined with a possibility to optimize the filter design for various applications.

### SUMMARY OF THE INVENTION

The invention is defined by the features of the independent claims. Some specific embodiments are defined in the dependent claims.

Novel three-layer filter media where all three layers have different basis weights and/or composition have been developed, thus enabling to provide more flexible product designs and enhanced capability of filter media. In the novel filter media, dust holding capacities and lifetime increase remarkably compared to prior art products.

According to a first aspect of the present invention, there is thus provided a filter medium comprising:
a first layer comprising first fibers and having a first grammage;
a second layer comprising second fibers and having a second grammage;
a third layer comprising third fibers and having a third grammage;
a first boundary area between the first layer and the second layer forms a first blended area comprising a first mixture of the first fibers and the second fibers; and
a second boundary area between the second layer and the third layer forms a second blended area comprising a second mixture of the second fibers and the third fibers; and
   wherein the grammage and/or composition of the first, second layer and third layer are different from one another and wherein the first grammage is less than or equal to the second grammage.

According to a second aspect of the present invention, there is provided a method of manufacturing the novel filter medium, wherein the method comprises the steps of:
a) providing a first homogeneous slurry, a second homogeneous slurry, and a third homogeneous slurry;
b) supplying the first homogeneous slurry onto a dewatering screen to form a first deposit;
c) supplying the second homogeneous slurry onto the first deposit to form a second deposit on top of the first deposit;
d) supplying the third homogeneous slurry onto the second deposit to form a third deposit on top of the second deposit;
e) removing the water from the first deposit, the second deposit, and the third deposit to form a wet fibrous mat or sheet; and
f) drying the wet fibrous mat or sheet while heating to form a substrate;
wherein the first homogeneous slurry comprises water and the first fibers; the second homogeneous slurry comprises water and the second fibers; the third homogeneous slurry comprises water and the third fibers; and
wherein the grammage and/or composition of the first layer, second layer and third layer are different from one another.

Embodiments of the invention comprise filter units comprising the novel filter medium. Examples of such filter units include but are not limited to gas turbine filter units, HVAC filter units, transmission fluid filter units and oil filter units. In general, the filter units comprising the novel filter medium may be capable to filter any gas or liquid, including air/oil separation and filtration of water, fuel and hydraulic liquids.

Considerable advantages are obtained by the invention. First, the structure where all three layers have a different composition and/or different basis weights provides product designs with increased dust holding capacities and longer filter lifetime. By way of an example, in transmission filtration area, dust holding capacities and lifetime increased +30% compared to prior known products. Moreover, in addition to high dust holding capacity and long lifetime the new filter medium provides low pressure drop, superior uniformity and outstanding mechanical resistance, even in wet conditions or after folding.

The new filter medium provides therefore solutions for increasing demand in new electronic vehicles (EVs) and for air filtration media used in heat, ventilation and air conditioning (HVAC) and gas turbines (GT).

Further features and advantages of the present technology will appear from the following description of some embodiments.

### BRIEF DESCRIPTION OF THE DRAWINGS

FIG. 1 is a cross-sectional image of Example 2.1, obtained using a scanning electron microscope (SEM) showing the 3-layer structure with boundary area between each layer; and

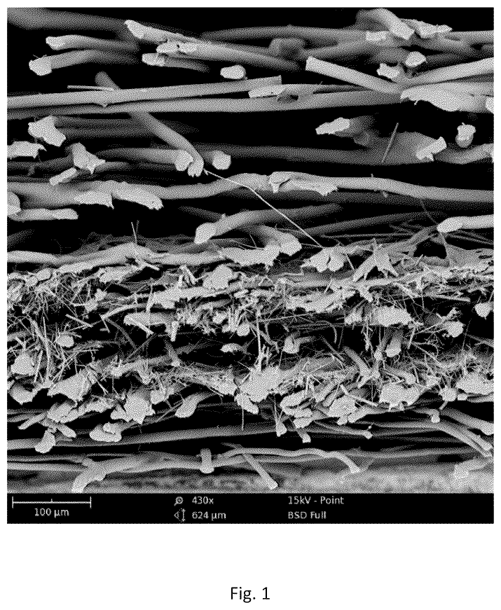

FIG. 2 is a cross-sectional image of Example 2.2, obtained using a scanning electron microscope (SEM) showing the 3-layer structure with boundary area between each layer.

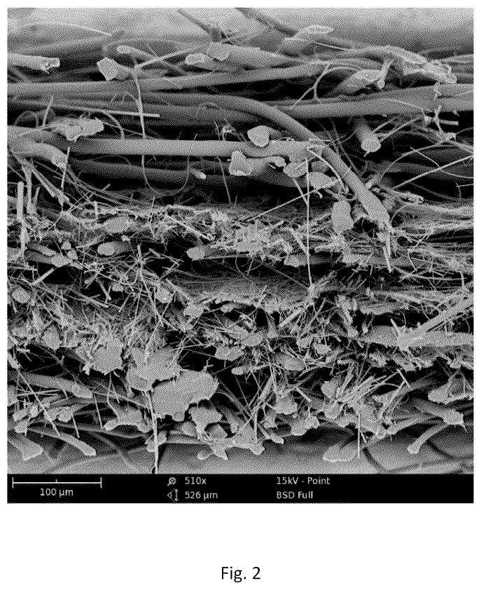

### EMBODIMENTS

### Definitions

In the present context, the term “fiber” refers to a fibrous or filamentary structure having a high aspect ratio of length to diameter. As used herein, “polymeric fibers” refer to fibers made from fiber-forming polymers synthesized from chemical compounds and modified or transformed natural polymers. Preferred, non-limiting examples of “synthetic fibers” include polyester fibers, polyethylene fibers, polyethylene terephthalate fibers, polyolefin fibers, polybutylene terephthalate fibers, polyamide fibers, and combinations thereof.

As used herein, “a boundary area” refers to an area between two layers, wherein the two layers are intermingled at the interface of the layers, forming a blended area comprising a mixture of the fibers of the two layers. While some hydrogen bonding may occur between the layers in dewatering and drying process of the filter medium, the main reason the layers are joined together is due to the fibers intermingling, resulting in a boundary area or mixed zone between the layers.

It has been found that a filter medium comprising three layers, wherein the grammage and/or composition of the first layer, the second layer and the third layer are different from one another, is capable of holding dust in an efficient manner without decreasing the lifetime of the filter medium. On the contrary, the lifetime of the novel filter medium is extended when the dust holding capacity is increased.

The first layer of the filter medium comprises first fibers having a first grammage. The second layer comprises second fibers having a second grammage. Also the third layer comprises third fibers having a third grammage. In the filter medium of the present invention, the first grammage is less than or equal to the second grammage.

As used herein, the term first, second and third grammage relate to the average grammage of the first, second and third layer, respectively.

The filter medium comprises a first boundary area between the first layer and the second layer, forming a first blended area comprising a first mixture of the first fibers and the second fibers. The filter medium comprises also a second boundary area between the second layer and the third layer, forming a second blended area comprising a second mixture of the second fibers and the third fibers.

In the boundary areas, fibers forming the two layers are intermingled with each other, which enables a good adhesion of the layers without the need of an adhesive that is separate from the two layers. The formation of the boundary areas or mixed zones results from applying the slurries for each of the layers simultaneously or immediately one after the other. The individual layers are not strictly separated from each other and are interconnected by means of a mixed zone or boundary area. In the mixed zone the layers are joined together by mechanical entangling or fibrous interlock. Unlike other multi-layer media where the layers are glued together, in this case the individual layers cannot be separated by heat or moisture.

Therefore, in embodiments, the first layer is not bonded to the second layer by way of an adhesive that is separate from the first layer and the second layer. Also the second layer is not bonded to the third layer by way of an adhesive that is separate from the second layer and the third layer.

In some embodiments, the second grammage is greater than or equal to the third grammage, preferably greater than the third grammage.

The first grammage may have a first grammage range of between 10 gsm and 50 gsm, preferably between 12 gsm and 40 gsm. The second grammage may have a second grammage range of between 25 gsm and 90 gsm, preferably between 25 gsm and 70 gsm. The third grammage may have a third grammage range of between 10 gsm and 25 gsm, preferably 10 gsm and 20 gsm.

In the present filter medium the grammage and/or composition of the first, second layer and third layer are different from one another. In some embodiments the grammages of the first, second layer and third layer are different from one another. In some embodiments the grammages and compositions of the first, second layer and third layer are different from one another. In some embodiments, the compositions of the first, second layer and third layer are different from one another. Difference in composition means either that the same fibers are used in different proportions or that different fibers can be used.

In embodiments, the first layer has a first bulk, the second layer has a second bulk, and the third layer has a third bulk. “Bulk” refers to the ratio of layer thickness to its basis weight.

In some embodiments, the first bulk is greater than the second bulk. In some embodiments, the third bulk is greater than the second bulk.

The first bulk may be in a first bulk range of between 8 cm³/g and 35 cm³/g, more preferably 8-20 cm³/g, and most preferably 7-18 cm³/g. The second bulk may be in a second bulk range of between 4 cm³/g and 9 cm³/g, more preferably between 5 cm³/g and 8 cm³/g. The third bulk may have a third bulk range of between 7 cm³/g and 15 cm³/g, preferably between 10 cm³/g and 13 cm³/g.

Thus, the second layer typically has a lower bulk than the first layer and the third layer, meaning that the second layer is less open and usually can be considered as the functional layer with the highest filtration capacity. On the other hand, in some embodiments the third layer can be designed to be relatively open, which increases the water drainage from the filter. However, in the inventive filter medium the first layer and the third layer have a different grammage and/or composition, and both the first and the second layer are also different from the second layer.

The fibers of the filter medium may have an average fiber width. In some embodiments, the first fibers have a first average fiber width greater than a second average fiber width of the second fibers. In some embodiments, the third fibers have a third average fiber width greater than the second average fiber width of the second fibers.

The first average fiber width may be in a first average fiber width range of between 7 μm and 25 μm, preferably between 10 μm and 25 μm. The third fibers may have a third average fiber width in a third average fiber width range of between 4 μm and 25 μm, preferably between 8 μm and 25 μm. The second fibers may have a second fiber average fiber width in a second fiber average fiber width range of between 2.5 μm and 15 μm, preferably between 4 μm and 10 μm.

The fibers of the filter medium will have a linear density. In some embodiments, the first fibers may have a linear density range of between 0.5 and 7.0 dtex. In some embodiments, the third fibers may have a linear density range of between 0.1 and 7.0 dtex. In some embodiments, the second polymeric fibers have a linear density range of between 0.1 and 5 dtex.

The fibers of the filter medium may have an average fiber length. In some embodiments, the first fibers may have a first average fiber length in a first average fiber length range of between 4 mm and 25 mm, preferably between 5 mm and 10 mm.

In some embodiments, the third fibers have a third average fiber length in a third average fiber length range of between 2.5 mm and 25 mm.

In some embodiments, the second polymeric fibers have a second polymeric fiber average fiber length in a second polymeric fiber average fiber length range of between 2.5 mm and 40 mm, preferably between 5 mm and 20 mm.

The layers of the filter medium comprise fibers, preferably polymeric fibers. In some embodiments, the first fibers are first polymeric fibers selected from the group consisting of a polyester, a polyethylene, a polyethylene terephthalate, a polyolefin, a polybutylene terephthalate, a polyamide, and combinations thereof, preferably from polyethylene terephthalate and polyethylene terephthalate based bicomponent fibers. The first fibers may further comprise cellulosic fibers, such as pulp fibers and/or regenerated cellulosic fibers.

In some embodiments, the third fibers are third polymeric fibers selected from the group consisting of a polyester, a polyethylene, a polyethylene terephthalate, a polyolefin, a polybutylene terephthalate, a polyamide, and combinations thereof, preferably from polyethylene terephthalate and polyethylene terephthalate based bicomponent fibers. The third fibers may further comprise cellulosic fibers, such as pulp fibers and/or regenerated cellulosic fibers, such as Lyocell fibers.

In some embodiments, the second fibers comprise second polymeric fibers selected from the group consisting of a polyester, a polyethylene, a polyethylene terephthalate, a polyolefin, a polybutylene terephthalate, a polyamide, a polyacrylonitrile, and combinations thereof, preferably from polyethylene terephthalate, polyethylene terephthalate based bicomponent fibers and polyacrylonitrile.

In some embodiments, the second fibers may further comprise microglass fibers. The microglass fibers may have an average microglass fiber width in an average microglass fiber width range of between 0.5 and 2.5 μm.

In some embodiments, the second layer may comprise an adsorbent, preferably selected from activated carbon and zeolites. When present, the adsorbent may comprise activated carbon, preferably in granulated, powdered, fiber, nanofiber or nanotube form, and/or zeolites, preferably in polymeric or mineral form.

In some embodiments, the filter medium may further comprise a binder. When used, the binder is typically selected from acrylate, styrene acrylate, vinyl acetate, and vinyl acetate acrylate binders. Preferably, the binder is substantially free of melamine and/or formaldehyde content. In the context of the present invention a binder “substantially free of melamine and/or formaldehyde content” means that the melamine and/or formaldehyde content in the binder is less than 0.5 wt %, more preferably less than 0.2 wt %.

The binder may be applied in one or more steps.

In a preferred embodiment, binders are applied in a two-step process. First, a wet-end binder is applied onto the wet fibrous mat or sheet while the water is being removed from the sheet. The wet-end binder is used primarily as a processing aid to help to remove the fibrous mat off the dewatering screen. The wet-end binder may be applied to the media by any suitable method known to a skilled person such as a curtain coater, size press, dip and squeeze applicator or spraying. Preferably, the binder composition is sprayed onto the fibrous mat. Excess binder may be removed along with water via the dewatering screen by application of vacuum.

Second, after the mat is dried to form the substrate, an additional dry-end binder may be applied onto the substrate to improve the mechanical strength of the filter medium. The additional dry-end binder may be applied onto the substrate by spray coating. Other methods of application of the additional binder composition are also possible, such as curtain coating or dip and squeeze application.

If a binder is used, the filter medium will have a binder grammage. The binder grammage may be within a binder grammage range of between 5 gsm and 60 gsm.

In some embodiments, the filter medium will have a final grammage. The final grammage range may be in a final grammage range of between 50 gsm and 250 gsm, preferably between 60 gsm and 200 gsm.

The filter medium will have an air permeability. The air permeability of the filter medium may be between 100 to 700 litres/m²/second, more preferably 150-600 litres/m²/second.

In some preferred embodiments, the first layer may have an air permeability between 1500 to 25000 litres/m²/second, more preferably between 2000 and 20000 litres/m²/second.

In some preferred embodiments, the second layer may have an air permeability between 150 to 800 litres/m²/second, more preferably between 200 and 700 litres/m²/second.

### Method of Manufacturing the Filter Medium

The method of manufacturing the filter medium preferably comprises the steps of:
a) providing a first homogeneous slurry, a second homogeneous slurry, and a third homogeneous slurry;
b) supplying the first homogeneous slurry onto a dewatering screen to form a first deposit;
c) supplying the second homogeneous slurry onto the first deposit to form a second deposit on top of the first deposit;
d) supplying the third homogeneous slurry onto the second deposit to form a third deposit on top of the second deposit;
e) removing the water from the first deposit, the second deposit, and the third deposit to form a wet fibrous mat or sheet; and
f) drying the wet fibrous mat or sheet while heating to form a substrate;
wherein the first homogeneous slurry comprises water and the first fibers; the second homogeneous slurry comprises water and the second fibers; the third homogeneous slurry comprises water and the third fibers; and
wherein the grammage and/or composition of the first layer, second layer and third layer are different from one another.

In this method, first, second and third homogeneous slurries are provided. These slurries can be provided by any method known in the art such as by adding and mixing the fibers in water.

As used herein, the first homogeneous slurry comprises water and the first fibers. Likewise, the second slurry comprises water as well as the second fibers. Moreover, the third slurry comprises water and the third fibers.

Once the first, the second and the third homogeneous slurries are prepared, they are applied onto a dewatering screen. This screen can be any screen commonly used in a paper making process. Preferably, this screen is a dewatering endless screen. Upon supplying the first slurry onto the dewatering screen, a first deposit is formed on the screen. Subsequently, the second slurry is supplied onto the first deposit to form a second deposit on top thereof. Then, the third slurry is supplied onto the second deposit to form a third deposit on top of the second deposit.

Supplying the first, the second and the third slurries can be carried out for example by using different supplying lines from different headboxes of a wet-laid forming machine. In particular, the method may be a wet-laid triple headbox method, comprising a step wherein the first homogenous slurry is transferred to a first headbox zone while simultaneously transferring the second homogeneous slurry to a second headbox zone and the third homogeneous slurry to a third headbox zone.

In some embodiments, the first headbox zone, the second headbox zone and the third headbox zone may comprise separate compartments of a single headbox. In other embodiments, the first headbox zone, the second headbox zone and the third headbox zone may comprise separate headboxes operating in tandem.

During or after deposition of the individual slurries, water is removed to form a wet fibrous mat or sheet. Subsequently, the wet fibrous mat or sheet is dried while heating to form a substrate. This substrate comprises the first, the second, and the third layer, wherein the grammage and/or composition of the first, the second layer and third layer are different from one another.

Further, applying the first, the second and the third homogeneous slurries on top of each other results in a boundary area between adjacent layers, which forms a blended area comprising first and second or third and second fibers. The fibers of the first and second and the fibers of the third and second layers intermingle with each other such that there is a fibrous interlock rather than a sharp and defined edge which would separate the individual layers from each other.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

### EXPERIMENTAL

The following test methods were employed to obtain the data reported in the tables below.

Grammage/Basis weight: The basis weight or grammage is measured according to TAPPI Standard T410 and reported in grams per square meter (g/m² or gsm).

Thickness: The thickness at 100 kPa is measured according to ISO Standard 534:1988 and reported in micrometers (μm). The thickness of each layer within the media is measured from a cross-section image of the media obtained using scanning electron microscopy (SEM). The cross-sectional SEM image shows how the individual layers are distributed so the thickness can measured for each layer. For example, the first layer thickness is measured from the outer surface of the material to the middle of the first boundary area. The second layer thickness is measured from the middle of the first boundary area to the middle of the second boundary area. The third layer thickness is measured from the middle of the second boundary area to the opposite outer surface.

Bulk: The bulk of the material is determined based on thickness and basis weight of a material:

$$Bulk ( {cm}^{3} / g ) = \frac{Thickness ( µm )}{Basis weight ( \frac{g}{{m}^{2}} )}$$

The bulk of each layer is also calculated based on this formula, with the thickness value obtained from SEM images. The basis weight of each layer can be measured either by splitting the sheet into the individual layers using a sheet splitter or by using digital simulation software such as the PoroDict and MatDict modules in the Geodict® simulation software.

The simulation software GeoDict® may be described as a digital material laboratory to import, simulate, and analyze a large variety of microstructures, as well as model their behavior under varying conditions. The modules used in the software are based on mathematical and analytical models (Stokes and Navier-Stokes for example). The composition of fibers used in the individual layers, the characteristic of those fibers (including diameter, linear density, curl, flexibility), the binder chemistry, binder content, binder distribution across the layers is input in the software and the basis weight of each layer is calculated as an output.

Air permeability: The air permeability was obtained using the FlowDict digital simulation software module, which is part of the simulation software Geodict® and is reported in Litre/m²/second. Geodict uses state-of-the-art numerical methods and voxel-based solvers to simulate flow and filtration parameters of the media.

Dust holding capacity: The Dust Holding Capacity (DHC) is measured according to ISO 4548/12 for engine oil media and according to ISO 16890 for industrial filtration media. For transmission media, the DHC measurement was a multipass test adapted from ISO 16899 (flow: 3.5 L/min, BUGL: 10 mg/L, Test area 113 cm², Final pressure drop=+200 kPa). For industrial filtration media, the DHC measurement was adapted from ISO 16899 (face velocity of 5.3 cm/s, test area: 100 cm², PTI fine test dust was used as a contaminant).

Average diameter per layer: The average diameter per layer was calculated based on the composition of fibers in each layer. The average diameter per layer may also be estimated from scanning electron microscope images of each layer by measuring the diameter of at least 50 fibers, preferably at least 100 fibers, in each layer and calculating the mean value.

Tensile Strength: The tensile strength is measured according to ISO 1924-2 and reported in N/m. Test pieces 15 mm×180 mm are cut in the Machine Direction (MD) and Cross Direction (CD) over the width of the roll and tested with the tensile tester. The results are reported as a strength ratio, which can be considered as:

$$Strength ratio = \frac{Tensile strength in CD ( \frac{N}{m} )}{Tensile strength in MD ( \frac{N}{m} )} .$$

Dry Burst Strength: The burst strength is measured according to ISO 13938-1 and is reported in kPa.

Example 1: Example 1 was made on a wet-laid machine. The grammage of the first layer, the second layer and the third layer of Example 1 were different from each other. All layers comprise a mixture of polyethylene terephthalate (PET) and polyethylene terephthalate based bicomponent fibers (PET/PE) according to Table 1. 4 g/m² of CHP 688 acrylate binder was added via spray-coating on the wet-end of the wet-laid machine. After the three-layer substrate was formed, an additional 34 g/m² of CHP 689 acrylate binder was sprayed. The final basis weight of Example 1 was 150 g/m² after binder addition.

Comparative example 1 was a commercially available three-layer filter media made on a wet-laid machine and having an A-B-A structure with the same grammage and composition in the first layer and in the third layer. 4 g/m² of CHP 688 acrylate binder was added via spray-coating on the wet-end of the wet-laid machine. After the three-layer substrate was formed, an additional 22.7 g/m² of CHP 688 acrylate binder and 6.3 g/m² of melamine formaldehyde binder, Madurit 125, was sprayed onto the substrate. The final basis weight of Comparative example 1 was 150 g/m² after binder addition.

TABLE 1
Composition of layers

| | Example 1 | | | Comparative example 1 | | |
|---|---|---|---|---|---|---|
| | First | Second | Third | First | Second | Third |
| | layer | layer | layer | layer | layer | layer |
| | (wt %) | (wt %) | (wt %) | (wt %) | (wt %) | (wt %) |
| PET 0.1 dtex/3 mm/4.0 μm | — | 54 | — | | 41 | — |
| PET 0.5 dtex/5 mm/7.1 μm | 30 | 29 | 30 | | 31 | — |
| PET 1.7 dtex/6 mm/13.3 μm | 60 | 7 | 60 | 90 | | 90 |
| PET/PE Bico | 10 | 10 | 10 | 10 | 10 | 10 |
| 2.2 dtex/5 mm/14.7 μm | | | | | | |
| PET 17 dtex/38 mm/40.6 μm | — | — | — | — | 18 | — |
| Grammage (g/m²) | 37 | 71 | 16 | 26 | 65 | 26 |
| Bulk | 7.8 | 7.4 | 11.7 | 9.7 | 7.9 | 10.3 |

| | | |
|---|---|---|
| Wet-end binder (g/m²) | 4.0 | 4.0 |
| Melamine Binder (g/m²) | — | 6.3 |
| Dry-end binder (g/m²) | 22.0 | 22.7 |

Example 2: Examples 2.1 and 2.2 were made on a wet-laid machine. Each layer of Examples 2.1 and 2.2 comprised a different grammage and a different composition of fibers. The composition of fibers in each layer is shown in Table 2. The second layer comprised also microglass fibers. The binder composition and method of addition was the sample for Examples 2.1 and 2.2. 3.5 g/m² of CHP 688 acrylate binder was added via spray-coating on the wet-end of the wet-laid machine. After the three-layer substrate was formed, an additional 34 g/m² of CHP 688 acrylate binder was sprayed. The final basis weight of the Example 2.1 and Example 2.2. were 70 g/m² after binder addition.

Comparative examples 2.1 and 2.2 were commercially available three-layer filter media made on a wet-laid machine and having an A-B-A structure with the same grammage and composition in the first layer and in the third layer. The second layer of comparative examples 2.1 and 2.2. comprised microglass fibers. The binders used in Comparative examples 2.1 and 2.2 were identical to the binders used in Examples 2.1 and 2.2. The final basis weight of Comparative examples 2.1 and 2.2 were 70 g/m² after binder addition.

TABLE 2
Composition of layers

| | Example 2.1 | | | Comparative example 2.1 | | | Example 2.2 | | | Comparative example 2.2 | | |
|---|---|---|---|---|---|---|---|---|---|---|---|---|
| | First | Second | Third | First | Second | Third | First | Second | Third | First | Second | Third |
| | layer | layer | layer | layer | layer | layer | layer | layer | layer | layer | layer | layer |
| | (wt %) | (wt %) | (wt %) | (wt %) | (wt %) | (wt %) | (wt %) | (wt %) | (wt %) | (wt %) | (wt %) | (wt %) |
| PET 0.5 dtex/5 mm/7.1 μm | — | 15 | 49 | 49 | 20 | 49 | — | 15 | 49 | 49 | 20 | 49 |
| PET 1.5 dtex/6 mm/11.8 μm | 10 | 27 | 42 | 42 | 36 | 42 | 10 | 27 | 42 | 42 | 36 | 42 |
| PET 3.0 dtex/6 mm/15.5 μm | 80 | — | — | | — | | 80 | — | — | | — | |
| PET-Bico | 10 | — | 9 | 9 | — | 9 | 10 | — | 9 | 9 | — | 9 |
| 2.2 dtex/5 mm/14.7 μm | | | | | | | | | | | | |
| PET 4 dtex/6 mm/21.1 μm | — | 11 | — | — | 14 | — | — | 11 | — | — | 14 | — |
| Microglass 0.6 mm/0.6 μm | — | 19 | — | — | 12 | — | — | 12 | — | — | 12 | — |
| Microglass 0.7 mm/1.0 μm | — | 19 | — | — | 12 | — | — | 12 | — | — | 12 | — |
| Microglass 0.6 mm/2.4 μm | — | 9 | — | — | 6 | — | — | 6 | — | — | 6 | — |
| Grammage (g/m²) | 24 | 29 | 10 | 15 | 33 | 15 | 15 | 38 | 10 | 10 | 42 | 10 |
| Bulk (cm3/g) | 14.8 | 4.6 | 13 | 11.3 | 6.4 | 8.1 | 10.8 | 5.6 | 11.5 | 14.4 | 5.7 | 9.4 |

| | | | | |
|---|---|---|---|---|
| Wet-end binder (g/m²) | 3.5 | 3.5 | 3.5 | 3.5 |
| Dry-end binder (g/m²) | 3.5 | 3.5 | 3.5 | 3.5 |

Example 3: Example 3 was made on a wet-laid machine. The grammage and composition of the first layer, the second layer and the third layer of Example 3 were different from each other. All layers comprise a mixture of polyethylene terephthalate (PET) and polyethylene terephthalate based bicomponent fibers (PET/PE) according to Table 1. 4 g/m² of CHP 688 acrylate binder was added via spray-coating on the wet-end of the wet-laid machine. After the three-layer substrate was formed, an additional 34 g/m² of CHP 689 acrylate binder was sprayed. The final basis weight of Example 1 was 150 g/m² after binder addition.

Comparative example 3 was a commercially available three-layer filter media made on a wet-laid machine and having an A-B-A structure with the same grammage and composition in the first layer and in the third layer. 4 g/m² of CHP 688 acrylate binder was added via spray-coating on the wet-end of the wet-laid machine. After the three-layer substrate was formed, an additional 22.7 g/m² of CHP 688 acrylate binder and 6.3 g/m² of melamine formaldehyde binder, Madurit 125, was sprayed onto the substrate. The final basis weight of Comparative example 1 was 150 g/m² after binder addition.

TABLE 3
Composition of layers

| | Example 3 | | | Comparative example 3 | | |
|---|---|---|---|---|---|---|
| | First | Second | Third | First | Second | Third |
| | layer | layer | layer | layer | layer | layer |
| | (wt %) | (wt %) | (wt %) | (wt %) | (wt %) | (wt %) |
| PET 0.1 dtex/3 mm/ | — | — | 13 | | 29 | — |
| 4.0 μm | | | | | | |
| PET 0.5 dtex/5 mm/ | — | 30 | 56 | 12 | 30 | 12 |
| 7.1 μm | | | | | | |
| PET 1.7 dtex/6 mm/ | 90 | 63 | 21 | 78 | 13 | 78 |
| 13.3 μm | | | | | | |
| PET/PE Bico | 10 | 7 | 10 | 10 | 16 | 10 |
| 2.2 dtex/5 mm/14.7 | | | | | | |
| μm | | | | | | |
| PET 17 dtex/38 mm/ | — | — | — | — | 12 | — |
| 40.6 μm | | | | | | |
| Grammage (g/m²) | 12 | 22 | 91 | 28 | 97 | 28 |
| Bulk | 17.8 | 7.8 | 4.8 | 7.2 | 4.4 | 6.7 |

| | | |
|---|---|---|
| Wet-end binder (g/m²) | 5 | 7 |
| Melamine binder (g/m²) | 6 | — |
| Dry-end binder (g/m²) | 34 | 39 |

Properties of the filter media. The comparative and working examples were tested for various properties including dust holding capacity. Strength ratio, dry burst strength, air permeability and average fiber diameter per layer were obtained as discussed above. The results are summarized in the tables below.

TABLE 4
Dust holding capacity (DHC). DHC is given as an improvement
over corresponding comparative example (%)

| | Dust holding capacity (DHC) improvement |
|---|---|
| | over comparative example (%) |
| Example 1 | 31% |
| Example 2.1 | 12% |
| Example 2.2 | 14% |
| Example 3 | 20% |

TABLE 5
Dry Burst Strength and Strength ratio

| | Dry | Strength ratio |
|---|---|---|
| | Burst | Tensile strength CD/ |
| | Strength | Tensile strength MD |
| | (kPa) | (%) |
| Example 1 | 780 | 77 |
| Comparative example 1 | 700 | 78 |
| Example 2.1 | 200 | 56 |
| Comparative example 2.1 | 250 | 52 |
| Example 2.2 | 180 | 49 |
| Comparative example 2.2 | 200 | 52 |
| Example 3 | 1484 | 85 |
| Comparative example 3 | 1170 | 78 |

TABLE 6
Simulated air permeability

| | First | Second | Third |
|---|---|---|---|
| | layer | layer | layer |
| | (l/m²/s) | (l/m²/s) | (l/m²/s) |
| Example 1 | 2183 | 209 | 4676 |
| Example 2.1 | 11900 | 650 | 6900 |
| Example 2.2 | 18500 | 370 | 6900 |
| Example 3 | 14968 | 3444 | 282 |

TABLE 7
Average diameter per layer

| | First layer | Second layer | Third layer |
|---|---|---|---|
| | average | average | average |
| | diameter | diameter | diameter |
| | (μm) | (μm) | (μm) |
| Example 1 | 11.6 | 6.6 | 11.6 |
| Comparative example 1 | 13.4 | 12.6 | 13.4 |
| Example 2.1 | 15.1 | 7.0 | 10.0 |
| Example 2.2 | 15.1 | 7.0 | 10.0 |
| Comparative example 2.1 | 9.9 | 9.0 | 9.9 |
| Comparative example 2.2 | 9.9 | 9.0 | 9.9 |
| Example 3 | 13.4 | 11.5 | 8.8 |
| Comparative example 3 | 12.7 | 12.4 | 12.7 |

The above data shows that having different grammage and/or composition in each layer results in significant improvements in dust holding capacity (DHC), while retaining or improving the mechanical properties of the media such as burst strength or strength ratio. In particular, when the grammage of the first layer is also kept lower than the second layer, the first layer can function as a pre-filter or a layer that functions to increase DHC. This is also evident from the simulated air permeability data, where the first layer is more open than the middle layer. The above data, also shows that in some preferred embodiments, the second layer (the middle layer) is the efficiency layer. By varying the composition and/or grammage of each layer, the permeability of the layers can be varied.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some embodiments of the present invention find industrial application in filter manufacturing industry, providing filter media for oil filtration, air intake filtration in the transportation area, for HVAC filtration, as well as in the field of gas turbines.

### CITATION LIST

### Patent Literature

WO 2015/000806 A1
Non Patent Literature

1. A filter medium comprising:
a first layer comprising first fibers and having a first grammage;
a second layer comprising second fibers and having a second grammage;
a third layer comprising third fibers and having a third grammage;
a first boundary area between the first layer and the second layer forms a first blended area comprising a first mixture of the first fibers and the second fibers; and a second boundary area between the second layer and the third layer forms a second blended area comprising a second mixture of the second fibers and the third fibers; and wherein the grammage and/or composition of the first, second layer and third layer are different from one another, and wherein the first grammage is less than or equal to the second grammage.

2. The filter medium of claim 1, wherein the second grammage is greater than or equal to the third grammage.

3. The filter medium of any of claim 1, wherein the first layer has a first bulk, the second layer has a second bulk, and the third layer has a third bulk.

4. The filter medium of claim 3, wherein the first bulk is greater than the second bulk.

5. The filter medium of any of claim 3, wherein the third bulk is greater than the second bulk.

6. The filter medium of claim 5, wherein the first bulk is in a first bulk range of between 8 cm³/g and 35 cm³/g and the second bulk is in a second bulk range of between 4 cm³/g and 9 cm³/g.

7. (canceled)

8. The filter medium of claim 1, wherein the first fibers have a first average fiber width greater than a second average fiber width of the second fibers, and/or wherein the third fibers have a third average fiber width greater than the second average fiber width of the second fibers.

9. (canceled)

10. The filter medium of claim 8, wherein the first average fiber width in a first average fiber width range of between 7 pm and 25 pm.

11. The filter medium of claim 8, wherein the third fibers have a third average fiber width in a third average fiber width range of between 4 gm and 25 pm.

12. The filter medium of claim 7, wherein the second fibers have a second fiber average fiber width in a second fiber average fiber width range of between 2.5 pm and 15 pm.

13. The filter medium of claim 1, wherein the first layer is not bonded to the second layer by way of an adhesive that is separate from the first layer and the second layer.

14. The filter medium of claim 1, wherein the second layer is not bonded to the third layer by way of an adhesive that is separate from the second layer and the third layer.

15. The filter medium of claim 1 further comprising a binder.

16. The filter medium of claim 15, wherein the binder is substantially free of melamine content and/or formaldehyde content.

17. The filter medium of claim 1, wherein the air permeability of the filter medium is between 100 to 700 litres/m²/second.

18. A gas turbine or HVAC filter unit comprising the filter medium according to claim 1.

19. A transmission fluid filter unit comprising the filter medium according to claim 1.

20. A method of manufacturing the filter medium of claim 1, comprising the steps of:
a) providing a first homogeneous slurry, a second homogeneous slurry, and a third homogeneous slurry;
b) supplying the first homogeneous slurry onto a dewatering screen to form a first deposit;
c) supplying the second homogeneous slurry onto the first deposit to form a second deposit on top of the first deposit;
d) supplying the third homogeneous slurry onto the second deposit to form a third deposit on top of the second deposit;
e) removing the water from the first deposit, the second deposit, and the third deposit to form a wet fibrous mat or sheet; and
f) drying the wet fibrous mat or sheet while heating to form a substrate;
wherein the first homogeneous slurry comprises water and the first fibers; the second homogeneous slurry comprises water and the second fibers; the third homogeneous slurry comprises water and the third fibers; and wherein the grammage and/or composition of the first, second layer and third layer are different from one another.

21. (canceled)

22. The filter medium of claim 1 further comprising a binder selected from the group consisting of an acrylate, a styrene acrylate, a vinyl acetate, and a vinyl acetate acrylate.
